(19) United States
(12) Patent Application Publication
(10) Pub. No.: US 2025/0228340 A1
(43) Pub. Date: Jul. 17, 2025

(54) WRIST DEVICE

(71) Applicant: CASIO COMPUTER CO., LTD., Tokyo (JP)

(72) Inventor: Eri KAYANO, Tokyo (JP)

(21) Appl. No.: 19/022,330

(22) Filed: Jan. 15, 2025

(30) Foreign Application Priority Data
Jan. 16, 2024 (JP) 2024-004475

(51) Int. Cl. A44C 5/14

(52) U.S. Cl. CPC A44C 5/147

(57) ABSTRACT

Disclosed is a wrist device including: a case that includes a band attachment having a first through hole formed therein; an exterior that covers at least a portion of an upper surface side of the case and includes a connector having a second through hole formed therein that communicates with the first through hole in an assembled state in which the exterior is attached to the case; a spring bar that passes through the first through hole and the second through hole, which are in a communicating state, from one side to the other side and has protruding ends protruding to the one side and the other side; and a case attachment on a band side having engagement holes for receiving the respective protruding ends of the spring bar.

### REFERENCE TO RELATED APPLICATIONS

This application is based upon and claims the benefit of priority from the prior Japanese Patent Application No. 2024-004475, filed on Jan. 16, 2024, the entire contents of which are incorporated herein by reference.

### TECHNICAL FIELD

The present disclosure relates to a wrist device.

### DESCRIPTION OF RELATED ART

Japanese Patent Application Laid-Open Publication No. H8-332106 describes a configuration in which a hole (pivot hole) is formed in the attachment end (tip lug piece) of the band, and a pin (pivot 15L) that passes through a hole (spring bar attachment hole) on the case (watch case) side is fitted into the hole (pivot hole) in the attachment end (tip lug piece) of the band, thereby connecting the case (watch case) and the band.

### SUMMARY OF THE INVENTION

In order to solve the above problems, there is provided a wrist device including:
a case that includes a band attachment having a first through hole formed therein;
an exterior that covers at least a portion of an upper surface side of the case and includes a connector having a second through hole formed therein that communicates with the first through hole in an assembled state in which the exterior is attached to the case;
a spring bar that passes through the first through hole and the second through hole, which are in a communicating state, from one side to the other side and has protruding ends protruding to the one side and the other side; and
a case attachment on a band side having engagement holes for receiving the respective protruding ends of the spring bar.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a front view of main parts of a watch which is a wrist device according to an embodiment of the present disclosure;

FIG. 2 is a side view of main parts of a watch according to a first embodiment;

FIG. 3 is an exploded perspective view of the main parts of the watch according to the first embodiment;

FIG. 4 is a cross-sectional view of the main parts of the watch taken along line IV-IV in FIG. 1;

FIG. 5 is a cross-sectional view of the main parts of the watch taken along line V-V in FIG. 2;

FIG. 6 is a perspective view of the main parts showing how a device case and a bezel are connected;

FIG. 7 is a perspective view of the main parts showing how a tip lug member is connected to a watch body having the device case and the bezel connected thereto;

FIG. 8 is a perspective view of main parts, showing how a tip lug member is connected to a watch body having a device case and an exterior (bezel) connected thereto in a second embodiment;

FIG. 9 is a perspective view of main parts showing the tip lug member in the second embodiment;

FIG. 10 is a cross-sectional view of main parts of a watch according to the second embodiment taken at the position corresponding to FIG. 5;

FIG. 11 is a perspective view of main parts of a modification example in which a case attachment for attaching a band to a watch body is an end piece of the band formed of a plurality of pieces; and

FIG. 12 is a perspective view of main parts of a modification example in which a case attachment for attaching a band to a watch body is formed integrally with a band body.

### DETAILED DESCRIPTION

An embodiment of a wrist device according to the present disclosure will be described with reference to the drawings.

In the embodiment described below, the wrist device will be described as an example in which the wrist device is a wristwatch (hereinafter referred to as “watch 100”) worn on the arm. In addition, the following embodiments are subject to various technically preferable limitations for implementing the present disclosure, but the scope of the present disclosure is not limited to the following embodiments and illustrated examples. In the following description, the width direction of the watch 100 (the width direction of the watch body 10 and the band 2) is designated as “W”, the longitudinal direction of the band 2 is designated as “L”, and the thickness direction of the watch 100 (the vertical direction) is designated as “Z”. The width direction W corresponds to the 3 o'clock to 9 o'clock direction in an analog clock, and the longitudinal direction L corresponds to the 6 o'clock to 12 o'clock direction in an analog clock.

### First Embodiment

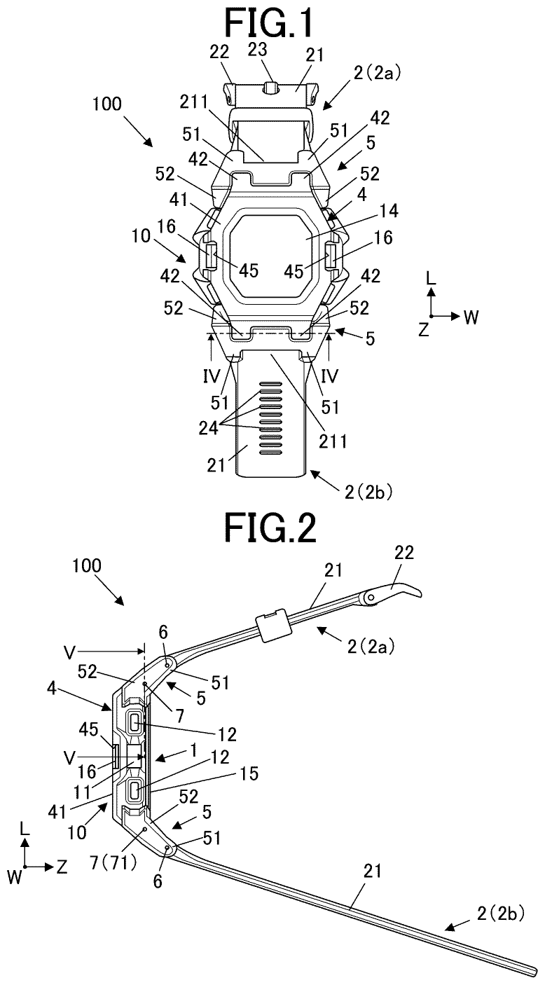

A first embodiment of a wrist device according to the present disclosure will be described with reference to FIGS. 1 to 7.

### [Configuration]

As shown in FIGS. 1 to 3, the watch 100 includes a watch body 10 and a band 2 connected to the watch body 10. First, the watch body 10 includes a case (hereinafter referred to as the “device case 1”) and an exterior 4. In the present embodiment, the exterior 4 is a bezel.

The device case 1 has a case body 11 and a band attachment 13. The material from which the device case 1 is formed is not particularly limited, but may be various hard materials, such as various metal materials such as titanium and stainless steel (SUS) or hard synthetic resins such as super engineering plastics such as polyarylate (PAR) and engineering plastics such as polyacetal (POM).

The case body 11 is formed in the shape of a hollow short column that is open at the top and bottom in the thickness direction Z of the watch 100 (see FIG. 2). An operation section 12 such as a crown or push buttons through which the user performs various input operations is provided on the outer side of the case body 11 (for example, the side portion on the 3 o'clock or 9 o'clock side of the watch). The arrangement, number, shape, and the like of the operation sections 12 are not limited to those shown in the figures.

Although not shown, various components such as modules are housed in the hollow space inside the case body 11. Although the specific configuration of the module will not be described in detail, when the watch 100 is an electronic watch, the module includes various operating parts of the watch 100, a controller that controls these, a battery, and the like. The watch 100 may have an analog display section with hands (not shown) or a digital display section with, for example, a liquid crystal display section.

For example, if the watch 100 is an analog display type, the operating parts include hands, a gear train (wheel train mechanism) that rotates the hands, and a drive part (motor, and the like). Furthermore, if the watch 100 is a digital display type, the operating part will be equipped with a display section including a Liquid Crystal display panel or the like instead of the above-mentioned components, and this display section will be positioned on the front side (viewing side) of the watch. The watch 100 may be a hybrid type having both digital and analog systems, in which case it has components of both systems as operating parts. The controller is mounted on a circuit board (not shown) and controls the display operation and the like performed by the operating part.

Japanese Patent Application Laid-Open Publication No. H8-332106 describes a configuration in which a hole (pivot hole) is formed in the attachment end (tip lug piece) of the band, and a pin (pivot 15L) that passes through a hole (spring bar attachment hole) on the case (watch case) side is fitted into the hole (pivot hole) in the attachment end (tip lug piece) of the band, thereby connecting the case (watch case) and the band.

The case of a wrist device such as a watch may be provided with an exterior such as a bezel. When connecting such a device having an exterior and a case to a band, if screws are used to secure the exterior parts to the case and additional screws are used to attach the band to the device having the exterior and the case, the number of screw parts increases. Additionally, space is required to secure the screw holes. Furthermore, if the screws are visible on the exterior, it is undesirable from the design standpoint, and design restrictions arise. In this regard, Japanese Patent Laid-Open Publication No. H8-332106 does not mention the case where an exterior such as a bezel is provided.

The present disclosure has been made to improve and solve the problems of such a situation and aims to provide a wrist device that can fix the exterior to the case without increasing the number of parts.

A windshield member 14 is attached to the end on the opening side on the upper side of the case body 11 (the upper side in the Z direction, the viewing side of the watch, the face side). The windshield member 14 is a transparent member (cover member) made of, for example, a glass material or a transparent resin material. Additionally, a back cover member 15 that closes the opening on the back side is provided on the lower side of the case body 11 (the lower side in the Z direction, the back side of the watch 100).

It is preferable that the windshield member 14 and the back cover member 15 are attached via a waterproof ring or the like (not shown). By interposing waterproof rings or the like between the windshield member 14 and the back cover member 15 and the case body 11, the upper and lower openings of the case body 11 are closed while ensuring airtightness. Alternatively, the case body 11 and the back cover member may be molded as a single section, with no opening provided on the lower side of the case body 11. It should be noted that FIG. 1 and other figures are schematic illustrations of the watch 100 and do not accurately depict the specific shape, configuration, and the like.

The band attachments 13 are used to connect the band 2 to the watch body 10 and are provided on one and the other ends of the side portion of the case body 11. In the present embodiment, as shown in FIG. 1 and the like, band attachments 13 are provided on the outer side of a case body 11 at positions corresponding to the 6 o'clock side and the 12 o'clock side of an analog watch. Each of the band attachments 13 is provided at approximately the center of the width direction W of the watch body 10 and is formed so as to protrude outward along the longitudinal direction L. The band attachment 13 has a through hole (hereinafter referred to as a “first through hole 131”) that penetrates the band attachment 13 in the width direction W. The specific shape of the band attachment 13 is not limited to the illustrated example.

The exterior (bezel) 4 has a main body 41 that covers at least a portion of the upper surface side of the device case 1 and is attached to the upper side of the device case 1. The main body 41 is a roughly frame-shaped member that is placed on the upper surface side of the case body 11 of the device case 1, with a large cut-out opening 411 formed in the central portion in the surface direction. When the exterior (bezel) 4 is placed on the upper surface side of the case body 11, the windshield member 14 provided on the upper surface side of the case body 11 is exposed from the opening 411. The material from which the exterior (bezel) 4 is formed is not particularly limited. The exterior (bezel) 4 may be made of, for example, various synthetic resins, various metal materials such as titanium and stainless steel (SUS), glass, ceramics, or the like.

In addition, the exterior (bezel) 4 is provided with band attachments 42 at positions on the main body 41 that correspond to the 6 o'clock and 12 o'clock sides of the watch. A pair of connectors 421 are provided on the underside of both ends in the width direction W of each of the band attachments 42. When the exterior (bezel) 4 is attached to the device case 1, the pair of connectors 421 are arranged on both sides, sandwiching the band attachment 13 of the device case 1 therebetween.

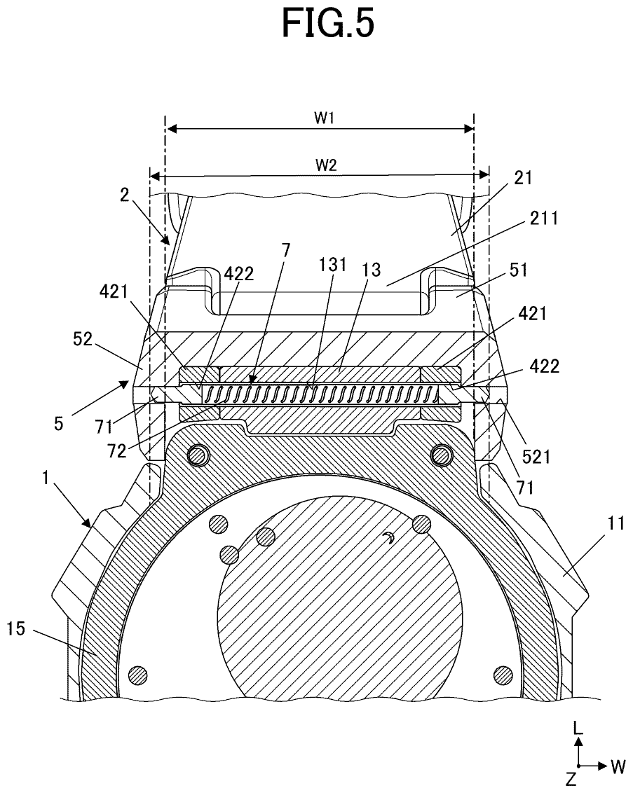

As shown in FIGS. 4 and 5, each connector 421 has a through hole (hereinafter referred to as a “second through hole 422”) that penetrates across the width direction W. The “second through holes 422” communicates with the “first through hole 131” of the device case 1 in an assembled state in which the exterior (bezel) 4 is attached to the device case 1.

The spring bar 7 is inserted through the “first through hole 131” and the “second through holes 422”, which are in a communicating state, from one side to the other side. The spring bar 7 is formed of a metal such as stainless steel (SUS). The material for forming the spring bar 7 is not limited to this. The spring bar 7 passes through the “first through hole 131” and the “second through holes 422”, and ends (protruding ends) 71 protrude to one side and the other side. As shown in FIGS. 4 and 5, the spring bar 7 has a biasing member 72, such as a spring, arranged within the shaft for biasing the ends (protruding ends) 71 outward along the axial direction. The spring bar 7 can be shortened in the axial direction by compressing it inwardly along the axial direction (which corresponds to the width direction W in FIGS. 4 and 5) against the biasing force of the biasing member 72.

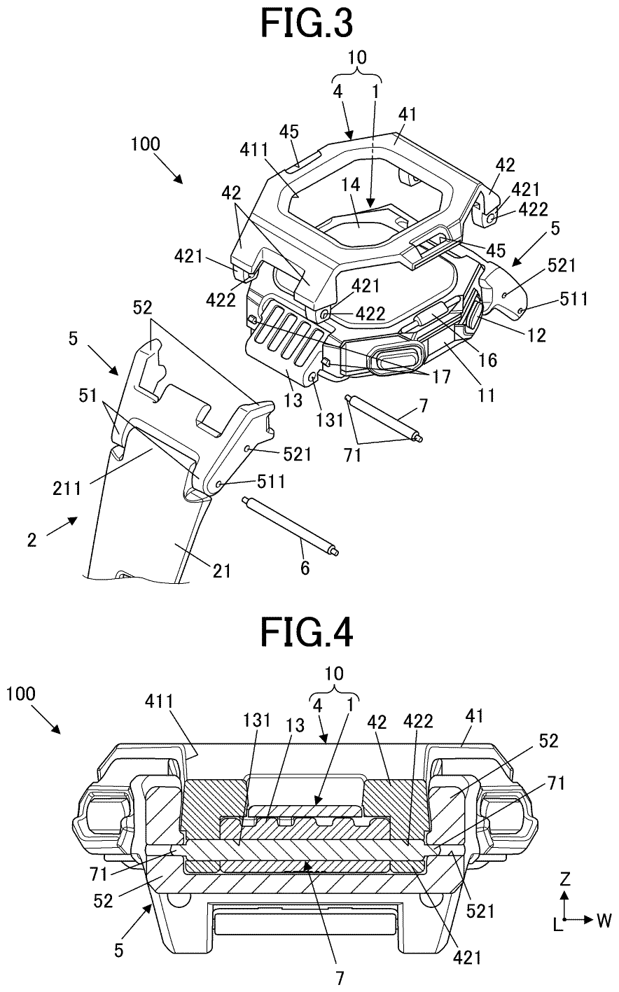

As shown in FIG. 3 and other figures, the exterior (bezel) 4 has fitting holes 45 at positions on the main body 41 that correspond to the 3 o'clock and 9 o'clock sides of the watch. First fitting protrusions 16 are formed to protrude at positions of the case body 11 of the device case 1 that correspond to the fitting holes 45. The first fitting protrusions 16 fit into the fitting holes 45 when the exterior (bezel) 4 is attached to the device case 1. In the illustrated example, each of the fitting holes 45 is a through hole, and the first fitting protrusion 16 is exposed from the fitting hole 45 in the fitted state, but the fitting hole 45 is not limited to a through hole. The fitting hole 45 may be any hole into which the first fitting protrusion 16 can be caught and may be a non-penetrating recess formed on the inside of the exterior (bezel) 4. In this case, the first fitting protrusion 16 can be designed not to be exposed externally.

Furthermore, as shown in FIG. 3, second fitting protrusions 17 are formed on both sides of the band attachment 13 of the device case 1 at positions corresponding to the band attachment 42 when the exterior (bezel) 4 is attached to the device case 1. A recess (not shown) is formed on the inside of the band attachment 42, and when the exterior (bezel) 4 is attached to the device case 1, the second fitting protrusion 17 fits into the recess. The portion into which the second fitting protrusion 17 fits may not be a recess but may be a hole that penetrates to the outside.

The first fitting protrusion 16 and the second fitting protrusion 17 are preferably formed, for example, in a claw or hook shape so that they can be easily fitted together and are difficult to come off once hooked. The specific shapes, number, positions, and the like of the first fitting protrusions 16 and the second fitting protrusions 17 are not limited to those shown in the figures. The fitting holes 45 and recesses on the exterior (bezel) 4 side are provided in accordance with the positions and shapes of the first fitting protrusions 16 and the second fitting protrusions 17. Furthermore, it is not essential that the device case 1 be provided with the first fitting protrusions 16 and the second fitting protrusions 17, and the device case 1 may be configured without the first fitting protrusions 16 or the second fitting protrusions 17. In this case, there is no need to provide the exterior (bezel) 4 with the fitting holes 45 or the recesses for hooking the first fitting protrusions 16 and the second fitting protrusions 17.

As shown in FIG. 1, the band 2 is attached to a watch body 10, and includes a main band (short band) 2a attached to the band attachment 13 on the 12 o'clock side of an analog watch, and a tip band (long band) 2b attached to the band attachment 13 on the 6 o'clock side. As shown in FIG. 1, a buckle 22 and a tongue 23 are attached to the free end side (the end side not attached to the watch body 10 including the device case 1) of the main band (short band) 2a. In addition, since the configuration of the main band 2a and the tip band 2b on the attachment side to the device case 1 (watch body 10 including the device case 1) is the same, in the following, the main band 2a and the tip band 2b will not be distinguished from each other and will be simply referred to as “band 2”.

In the embodiment, the band 2 has a band body 21. The band body 21 is formed from various synthetic resins such as urethane or rubber. The material for forming the band body 21 is not limited to this. The side of the band body 21 that is attached to the watch body 10 is a connecting-side end 211, and a through hole (not shown) is formed in the width direction W at the connecting-side end 211.

The connecting-side end 211 is provided with a tip lug member 5. In the present embodiment, the tip lug member 5 is a case attachment on the band 2 side that attaches the band 2 to the device case 1 (the watch body 10 including the device case 1). A protrusion is formed on the underside near the center of the tip lug member 5, which comes into contact with the device case 1, so that the tip lug member 5 does not rotate relative to the device case 1.

The tip lug member 5 of the present embodiment is substantially H-shaped when viewed from above. The tip lug member 5 is formed from various hard materials, for example, hard synthetic resins such as super engineering plastics such as polyarylate (PAR) and engineering plastics such as polyacetal (POM) or various metal materials such as titanium and stainless steel (SUS). One end side of the tip lug member 5 in the longitudinal direction L of the band 2 is a band body connector 51 formed in the shape of a pair of legs, and the other end side is a pair of connecting legs 52 that are connected to the device case 1 (the watch body 10 including the device case 1).

The band body connectors 51 are arranged on both sides in the width direction W of the connecting-side end 211 of the band body 21, as shown in FIG. 3, for example. The band body connector 51 has through holes 511 penetrating in the width direction W at a position corresponding to the through hole formed in the connecting-side end 211 of the band body 21. As shown in FIGS. 2 and 3, the tip lug member 5 is connected to the band body 21 via the connecting shaft 6 by inserting the connecting shaft 6 through the through hole 511 of the band body connector 51 and the through hole of the connecting-side end 211.

The tip lug member 5 also has through holes 521 as engagement holes for receiving the respective ends (protruding ends) 71 of the spring bar 7. As described above, the spring bar 7 is inserted into the “first through hole 131” and the “second through holes 422”, and the ends (protruding ends) 71, which are both ends (ends on one side and the other side) of the spring bar 7, protrude from the “first through hole 131” and the “second through holes 422” which are in a communicating state. The pair of connecting legs 52 of the tip lug member 5 are provided with through holes 521 at positions for receiving the ends (protruding ends) 71. That is, in the pair of connecting legs 52 of the tip lug member 5, through holes 521 are formed which penetrate in the width direction W at positions corresponding to the “first through hole 131” and the “second through holes 422” when the tip lug member 5 is attached to the watch body 10, as shown in FIGS. 4 and 5, for example.

With the band attachment 13 of the device case 1 and the connector 421 of the exterior (bezel) 4 integrated by the spring bar 7, the band 2 (tip lug member 5 of the band 2) is attached to the watch body 10 by fitting the band attachment 13 and the connector 421 between the pair of connecting legs 52. The through holes 521, which are engagement holes, are provided at positions spaced from the ends of the tip lug member 5 (connecting legs 52 of the tip lug member 5) on the side to be connected to the watch body 10, and by compressing the spring bar 7 while tilting the watch body 10 side slightly and fitting it between the pair of connecting legs 52, the band attachment 13 and the connectors 421 are fitted between the pair of connecting legs 52. Then, when the ends (protruding ends) 71 of the spring bar 7 protruding from the “first through hole 131” and the “second through holes 422” reach the positions corresponding to the through holes 521, the ends (protruding ends) 71 protrude into the through holes 521 and become engaged.

### [Action]

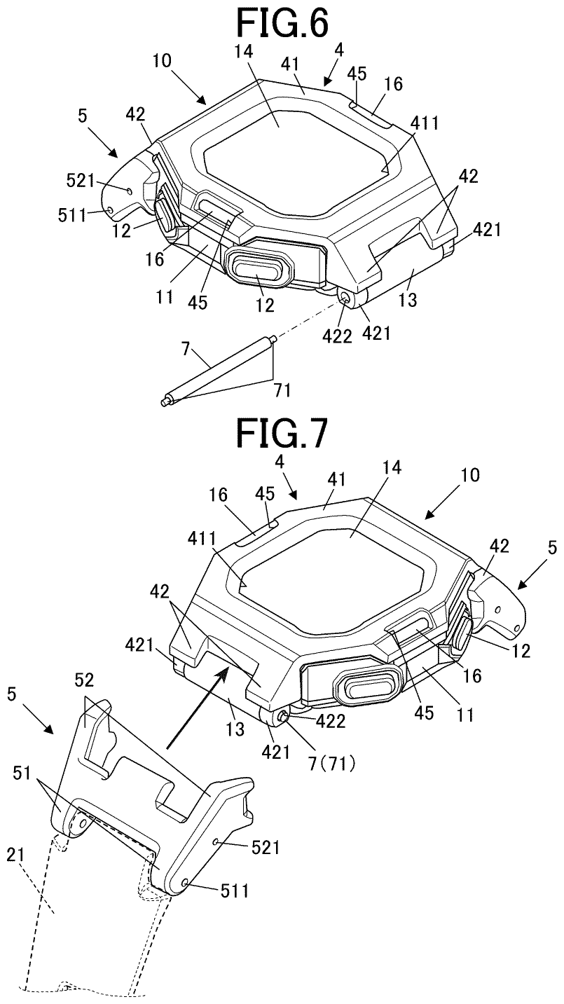

Next, the action of the watch 100, which is the wrist device of the present embodiment, will be described with reference to FIGS. 6 and 7. In addition, the band body 21 is indicated by a dashed line in FIG. 7.

First, when forming the watch body 10, a module and the like is housed inside the case body 11 of the device case 1, a windshield member 14 is attached to the opening on the front side, and a back cover member 15 is attached to the opening on the back side, thereby closing the openings on the front and back (top and bottom in the Z direction) of the case body 11.

Then, the exterior (bezel) 4 is attached to the top surface side of the device case 1 while performing alignment so that the windshield member 14 is exposed from the opening 411. At this time, the first fitting protrusions 16 provided on the 3 o'clock and 9 o'clock sides of the case body 11 are fitted into the first fitting holes 45 formed in the main body 41 of the exterior (bezel) 4. In addition, the second fitting protrusions 17 formed in the vicinity of the band attachment 13 of the device case 1 are fitted into the recesses formed on the inside of the band attachment 42 of the exterior (bezel) 4. As a result, the exterior (bezel) 4 is positioned relative to the device case 1, and the exterior (bezel) 4 and the device case 1 are temporarily fixed together.

When the exterior (bezel) 4 is temporarily attached to the device case 1, the “first through hole 131” formed in the band attachment 13 of the device case 1 and the “second through holes 422” formed in the connector 42 of the exterior (bezel) 4 communicate. The spring bar 7 is inserted through the “first through hole 131” and the “second through holes 422” in this communicating state (see FIG. 6). As a result, the spring bar 7 passes through the “first through hole 131” and the “second through holes 422”, with its ends on one side and the other side protruding. That is, as shown in FIG. 7, the device case 1 and the exterior (bezel) 4 are connected via the spring bar 7 to form the watch body 10, and the ends (protruding ends) 71 of the spring bar 7 protrude to the outside.

On the other hand, with regard to the band 2, the connecting shaft 6 is inserted through the through hole of the connecting-side end 211 of the band body 21 and the through holes 511 formed in the band body connector 51 of the tip lug member 5, thereby connecting the band body 21 and the tip lug member 5 via the connecting shaft 6. Then, the tip lug member 5 of the band 2 connected to the band body 21 is connected to the watch body 10 (see FIG. 7).

In this regard, as shown in FIG. 5, for example, the through holes 521, which are engagement holes, are provided at positions spaced from the ends of the tip lug member 5 (connecting legs 52 of the tip lug member 5) on the connecting side to the watch body 10. When the distance between the pair of connecting legs 52 is “W1” and the length from one end (protruding end) 71 of the spring bar 7 to the other end (protruding end) 71 is “W2”, in order to fit the band attachment 13 of the device case 1 and the connector 421 of the exterior (bezel) 4, which are connected by the spring bar 7, between the pair of connecting legs 52, it is necessary to compress the length of the spring bar 7 to “W1” or less.

For this reason, when attaching the band 2, the spring bar 7 is pressed and compressed while the watch body 10 side is tilted slightly obliquely and then pushed between the pair of connecting legs 52 of the tip lug member 5. This allows the band attachment 13 and the connector 421 to be fitted into the pair of connecting legs 52. Then, when the ends (protruding ends) 71 of the spring bar 7 protruding from the “first through hole 131” and the “second through holes 422” reach positions corresponding to the through holes 521 of the connecting legs 52, the spring bar 7, which had been compressed against the biasing force of the biasing member 72, returns to its original length “W2” due to the biasing force. As a result, the ends (protruding ends) 71 protrude into the through holes 521 and is engaged, completing the production of the watch 100 as a wrist device equipped with the band 2.

When removing the band 2 from the watch body 10, a jig or the like is inserted into the through hole 521 from the outside, and the spring bar 7 is compressed to a length of “W1” or less. In this state, the spring bar 7 and the band attachment 13 of the device case 1 and the connector 42 of the exterior (bezel) 4 connected by the spring bar 7 are removed from between the connecting legs 52.

In this manner, in the present embodiment, the device case 1 and the exterior (bezel) 4 are connected by the spring bar 7 to form the watch body 10, and this spring bar 7 is used to connect the watch body 10 to the band 2 to form the watch 100 as a wrist device. Therefore, there is no need to separately perform screw fastening or the like to fix the exterior (bezel) 4 to the device case 1.

### [Effect]

As described above, the watch 100, which is a wrist device in the present embodiment, comprises a device case 1 having a band attachment 13 in which a “first through hole 131” is formed, an exterior (bezel) 4 covering at least a portion of the upper surface side of the device case 1 and having a connector 421 having “second through holes 422” that communicate with the “first through hole 131” when assembled to the device case 1, a spring bar 7 that passes through the “first through hole 131” and “second through holes 422” in a communicating state from one side to the other and is arranged so that ends (protruding ends) 71 protrude to one side and the other side, and a tip lug member 5 that is a case attachment on the band 2 side having through holes 521 that are engagement holes that receive respective ends (protruding ends) 71 of the spring bar 7.

This allows the device case 1, the exterior (bezel) 4, and the band 2 to be connected by a single spring bar 7, eliminating the need to fix the exterior (bezel) 4 to the device case 1 by separate screw fastening or the like. Furthermore, by fixing it through the spring bar 7, the exterior (bezel) 4 can be fixed more firmly than when it is engaged with the device case 1 simply by fitting with a claw, protrusion, or the like.

Furthermore, since there is no need for screw fastening or the like, the number of screw parts can be reduced, and there is no need to reserve space for providing screw holes or the like required for screw fastening. This also makes it possible to reduce the overall size of the watch 100. Furthermore, the through holes 521 formed in the tip lug member 5, which is the case attachment on the band 2 side, only needs to be able to engage the ends (protruding ends) 71 of the spring bar 7, and even if a jig is inserted from the outside, it is sufficient if there is a thin hole. Therefore, compared to screw fastening, which exposes the screw holes and screw heads to the outside, the exterior (bezel) 4 can be fixed to the device case 1 by a method that does not affect the appearance.

Furthermore, since the spring bar 7 is used to secure the watch body 10 and the band 2 together, the securing can be achieved using less expensive materials than using, for example, a C-ring or the like. In addition, since the connecting legs 52 on the band 2 side are attached from the outside so as to sandwich the attachment on the watch body 10 side (i.e., the band attachment 13 of the device case 1 and the connector 421 of the exterior (bezel) 4), it is possible to create a design that makes the band 2 stand out, and there is a wide variety of design and appearance variations.

The device case 1 of the present embodiment has a case body 11, and the band attachments 13 are provided on one end and the other end of the side portion of the case body 11 (the 6 o'clock side and the 12 o'clock side in the present embodiment). This allows the band 2 to be attached from both sides of the case body 11, and the exterior (bezel) 4 can also be fixed to the case body 11 by the spring bars 7 on both sides. This allows the exterior (bezel) 4 to be fixed firmly to the device case 1 in a well-balanced manner. During disassembly, the band 2 can be removed from the case body 11 by pressing the tip of the spring bar 7 with a pin or the like.

In addition, the exterior (bezel) 4 of the present embodiment has a main body 41 arranged on the upper surface side of the device case 1, and band attachments 42 are provided on one end side and the other end side of the main body 41, respectively at positions corresponding to the band attachments 13. This allows the exterior (bezel) 4 to be fixed on both sides of the case body 11 by the spring bars 7. This allows the exterior (bezel) 4 to be fixed firmly to the device case 1 in a well-balanced manner.

### Second Embodiment

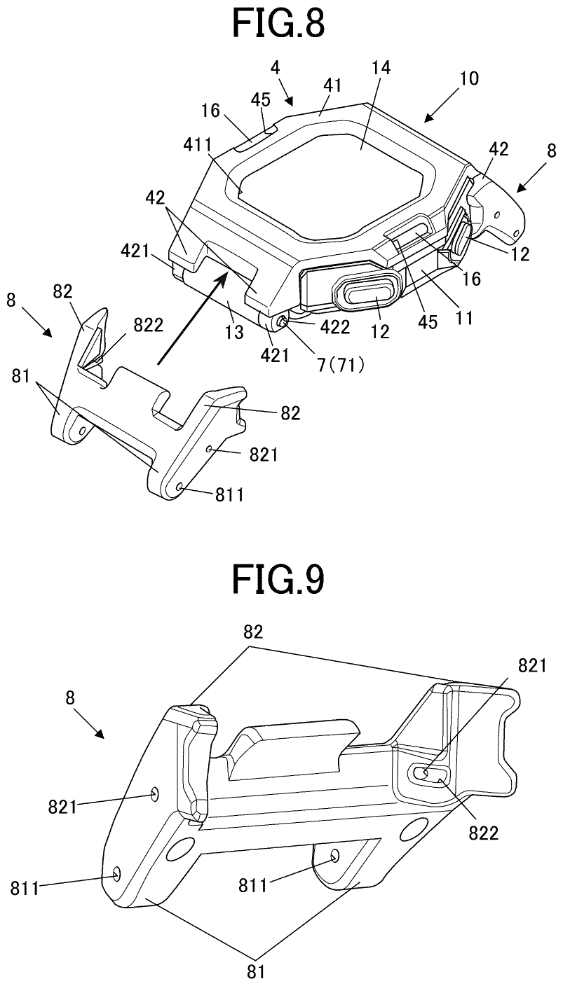

Next, a second embodiment of a wrist device according to the present disclosure will be described with reference to FIGS. 8 to 10. In FIG. 8, the band body 21 is omitted. In the present embodiment, the wrist device is also a watch. The wrist device (watch) of the present embodiment differs from the first embodiment only in the configuration of the tip lug member (case attachment) on the band 2 side that connects the band 2 to the watch body 10. Since the structure of the watch body 10 is the same as that of the first embodiment, the same members are given the same reference numerals, and the description thereof is omitted. Therefore, in the following, only the points that differ from the first embodiment will be described.

### [Configuration]

The tip lug member 8, which is a case attachment, is substantially H-shaped when viewed from above, similar to the tip lug member 5 of the first embodiment. One end of the tip lug member 8 in the longitudinal direction L of the band 2 constitutes a band body connector 81 formed in the shape of a pair of legs, and the other end constitutes a pair of connecting legs 82 that are connected to the case. The configuration of the band body connector 81 is similar to the configuration of the band body connector 51 shown in the first embodiment. The pair of connecting legs 82 of the tip lug member 5 are formed with through holes 821 which are engagement holes for receiving the respective ends (protruding ends) 71 of the spring bar 7.

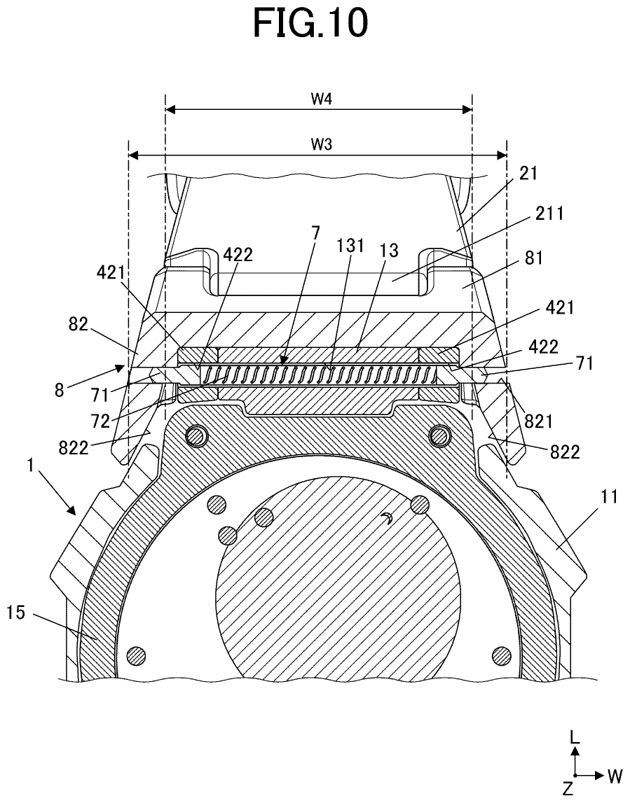

As in the first embodiment, the through holes 821 are provided at positions spaced from the ends of the tip lug member 8, the ends being on the connecting side to the device case 1 (the watch body 10 including the device case 1). In the present embodiment, as shown in FIGS. 8 and 9, the tip lug member 8 (the connecting legs 82 of the tip lug member 8) has guide grooves 822 formed from the ends on the connecting side to the device case 1 toward the through holes 821. Furthermore, the guide grooves 822 provided in the tip lug member 8 of the present embodiment are provided so as to face each other on the inner sides of the pair of connecting legs 82, and the distance between the facing guide grooves 822 narrows from the ends on the connecting side to the device case 1 toward the through holes 821, which are the engagement holes.

As shown in FIG. 10, when the width on the side of the ends of the guide grooves 822, which are formed in a pair of connecting legs 82, on the connecting side to the device case 1 (watch body 10 including the device case 1) is “W3”, the width of the portion where the through holes 821 are formed is “W4”, which is narrower than “W3”. The length from the end (protruding end) 71 on one end side of the spring bar 7 to the other end side is shorter than “W3” but longer than “W4”, and when the tip lug member 8 is attached to the watch body 10 from the ends on the connecting side to the device case 1, the spring bar 7 can be positioned within the guide grooves 822 at the connecting-side ends without being compressed. As the tip lug member 8 is pushed in so that the spring bar 7 moves along the guide grooves 822, the distance between the guide grooves 822 formed in the pair of connecting legs 82 gradually becomes shorter, and the spring bar 7 is naturally compressed. When it moves to the point where the through holes 821 are formed, the ends (protruding ends) 71 of the spring bar 7 are pushed outward in the axial direction (width direction W) by the biasing force of the biasing member 72 and protrudes into the through holes 821 and becomes engaged.

### [Action]

Next, the action of the watch, which is the wrist device in the present embodiment, will be described.

First, similarly to the first embodiment, the device case 1 and the exterior (bezel) are connected by the spring bar 7 to form the watch body 10. Then, the tip lug member 8, which is a case attachment connected to the band body 21, is connected to the watch body 10.

Specifically, the ends (protruding ends) 71 of the spring bar 7 are placed in the guide grooves 822, and the tip lug member 8 is pushed in from the ends on the connecting side to the device case 1 toward the through holes 821 so that the spring bar 7 moves along the guide grooves 822. As the tip lug member 8 is pushed in, the ends (protruding ends) 71 of the spring bar 7 abut against the guide grooves 822 due to the biasing force of the biasing member 72, such as a spring, and moves within the guide grooves 822 in a sliding contact state until it is guided to the through holes 821.

When the spring bar 7 moves to the position where the through holes 821 are formed, the ends (protruding ends) 71 of the spring bar 7 are pushed outward by the biasing force of the biasing member 72 and protrudes into the through holes 821. As a result, the ends (protruding ends) 71 are engaged with the through holes 821. Therefore, the user does not need to use a tool or the like to compress the spring bar 7, and simply, by positioning the ends (protruding ends) 71 of the spring bar 7 within the guide grooves 822 and pushing the tip lug member 8 along the guide grooves 822 toward the watch body 10, the spring bar 7 is guided while being compressed between the pair of guide grooves 822. Then, it can be easily engaged with the through holes 821, and the watch as a wrist device equipped with the band 2 is completed. Other points are the same as those in the first embodiment, and therefore the description thereof will be omitted.

### [Effect]

According to the present embodiment, in addition to the same effects as those of the first embodiment, the following effects are also achieved. That is, the through holes 821, which are the engagement holes in the present embodiment, are provided at a position spaced from the ends of the tip lug member 8, which is the case attachment, on the connecting side to the device case 1, and the guide grooves 822 are formed in the tip lug member 8 from the ends on the connecting side to the device case 1 toward the through holes 821, and the ends (protruding ends) 71 of the spring bar 7 abut against the guide grooves 822 due to the biasing force of the biasing member 72, such as a spring, and are guided in a sliding contact state to the through holes 821. As a result, by positioning the ends (protruding ends) 71 of the spring bar 7 within the guide grooves 822 and pushing the tip lug member 8 toward the watch body 10, the ends (protruding ends) 71 is guided along the guide grooves 822, and the ends (protruding ends) 71 of the spring bar 7 can be easily engaged with the through holes 821.

In addition, the case attachment of the present embodiment has a pair of connecting legs 82 arranged on one side and the other side of the “first through hole 131” and “second through holes 422” which are in a communicating state, and the guide grooves 822 are each provided facing each other on the inside of the pair of connecting legs 82, and the distance between the facing guide grooves 822 narrows from the ends on the connecting side to the device case 1 toward the through holes 821 which is the engagement holes. As a result, the user does not have to use a tool or the like to compress the spring bar 7, and by positioning the ends (protruding ends) 71 of the spring bar 7 within the guide grooves 822 and pushing the tip lug member 8 along the guide grooves 822 toward the watch body 10, the spring bar 7 is smoothly compressed and guided between the pair of guide grooves 822. Then, the spring bar 7 can be easily guided to the through holes 821 and can be engaged in the through holes 821.

### Modification Example

Although the embodiments of the present disclosure have been described above, it goes without saying that the present disclosure is not limited to such an embodiment, and various modifications are possible without departing from the gist of the present disclosure.

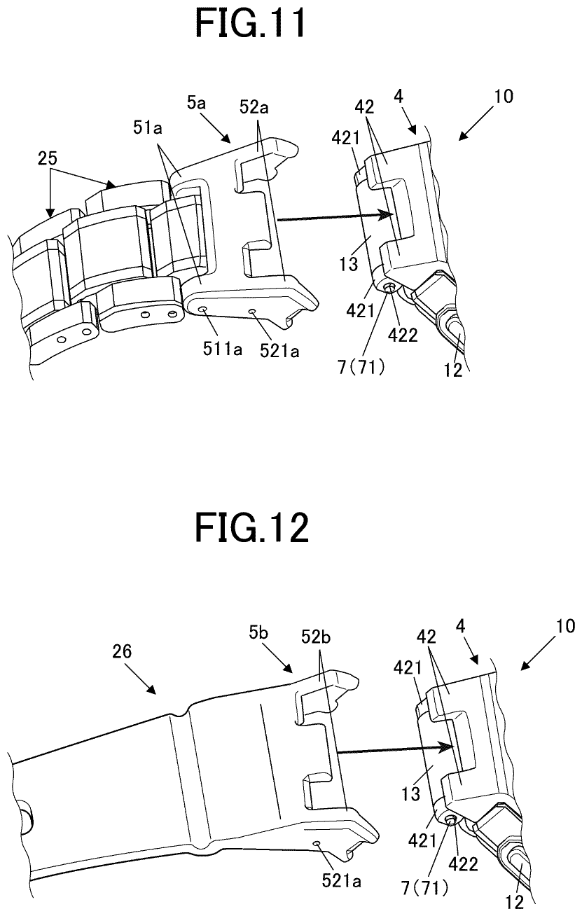

For example, in the first and second embodiments, the case attachment is illustrated as being the tip lug member 5, 8 connected to the band body 21 formed of resin or the like, but the case attachment is not limited to the tip lug member 5, 8. For example, as shown in FIG. 11, it may be a so-called end piece 5a that is provided on the connecting side with the watch body 10 in a bracelet-type band consisting of multiple band pieces 25 formed from various metal materials, hard resins, and the like.

Also, for example, as shown in FIG. 12, it may be a case attachment side end portion 5b formed integrally with the band body, which is provided by integral molding or the like on the side of the band body 26, which is formed of various resins or the like, to be connected to the watch body 10. In this case, the case attachment side end portion 5b is not limited to being integrally formed from resin, but may be, for example, a leather band or the like having engagement holes to engage the spring bar 7 formed on the connecting side with the watch body 10. Even in these cases, the band can be fixed to the watch body 10 by the spring bar 7 that connects the device case 1 and the exterior (bezel), allowing for a simple configuration with a reduced number of parts.

In addition, for example, in the present embodiment, the engagement holes of the case attachment, which is the tip lug member 5 or the like, is the through holes 521, but the engagement holes are not limited to being through holes. For example, if a spring bar having a mechanism such as a lever portion that can compress the length of the spring bar 7 against the biasing force of the biasing member 72 is used, there is no need to insert a jig or the like from the outside when removing the spring bar. Therefore, when using a spring bar having such a configuration, the engagement holes may be recesses or the like that receives the ends (protruding ends) of the spring bar.

For example, in the present embodiments, an example is given of the connectors 421 of the exterior (bezel) 4 being arranged on the outer side of the band attachment 13 so as to sandwich the band attachment 13 of the device case 1, but the shapes, arrangements, and the like of the band attachment 13 and the connector 421 are not limited to this. The band attachment 13 and the connector 421 are configured so that the “first through hole 131” on the device case 1 side and the “second through holes 422” on the exterior (bezel) 4 side are in communication, and for example, the band attachment 13 of the device case 1 may be provided on the outer side of the connector 421 so as to sandwich the connector 421 of the exterior (bezel) 4.

In addition, for example, in the present embodiments, the exterior connected to the device case by the spring bar 7 is a bezel, but the exterior is not limited to a bezel. The exterior may be any member that is externally attached to the device case, and broadly includes various members that are provided in a position where they can be fixed by the spring bar 7. In addition, while the above embodiments illustrate a case in which the band attachment 13 is integrally formed with the device case 1, the band attachment 13 may be separate from the device case 1 as long as it has a first through hole and a configuration for attaching a band to the device case.

Furthermore, for example, in the present embodiments, the wrist device is a watch 100 which is a wristwatch, but the wrist device of the present disclosure is not limited to a watch or timepiece. The present disclosure can be widely applied to any device in which a band 2 is attached to a watch body 10, for example, wrist devices such as various electronic devices such as smart watches and sports watches, and wearable devices that acquire biometric information such as heart rate and blood flow information in addition to the time.

Although several embodiments of the present disclosure have been described above, the scope of the present disclosure is not limited to the above-described embodiments, but includes the scope of the invention described in the claims and its equivalents.

1. A wrist device comprising:
a case that includes a band attachment having a first through hole formed therein;
an exterior that covers at least a portion of an upper surface side of the case and includes a connector having a second through hole formed therein that communicates with the first through hole in an assembled state in which the exterior is attached to the case;
a spring bar that passes through the first through hole and the second through hole, which are in a communicating state, from one side to the other side and has protruding ends protruding to the one side and the other side; and
a case attachment on a band side having engagement holes for receiving the respective protruding ends of the spring bar.

2. The wrist device according to claim 1, wherein the case include a case body.

3. The wrist device according to claim 1, wherein
the band attachment is provided on each of one end side and the other end side of a side portion of a case body.

4. The wrist device according to claim 2, wherein
the band attachment is provided on each of one end side and the other end side of a side portion of the case body.

5. The wrist device according to claim 1, wherein
the exterior includes a main body arranged on the upper surface side of the case.

6. The wrist device according to claim 5, wherein
the connector is provided at each of positions located on one end side and the other end side of the main body and corresponding to the band attachment.

7. The wrist device according to claim 1, wherein
the band attachment and the case are integrated.

8. The wrist device according to claim 1, wherein
the engagement holes are provided at positions spaced from an end of the case attachment, the end being on a connecting side to the case.

9. The wrist device according to claim 8, wherein
the case attachment has guide grooves formed from the end on the connecting side to the case toward the engagement holes.

10. The wrist device according to claim 9, wherein
the protruding ends of the spring bar abut against the guide grooves by a biasing force of a spring and are guided to the engagement holes in a sliding contact state.

11. The wrist device according to claim 10, wherein
the case attachment includes a pair of legs arranged on one side and the other side of the first through hole and the second through hole in a communicating state.

12. The wrist device according to claim 11, wherein
the guide grooves are provided on respective inner sides of the pair of legs so as to face each other, and a distance between the facing guide grooves narrows from the end on the connecting side to the case toward the engagement holes.

13. The wrist device according to claim 1, wherein
the case attachment has guide grooves formed from an end on a connecting side to the case toward the engagement holes.

14. The wrist device according to claim 13, wherein
the protruding ends of the spring bar abut against the guide grooves by a biasing force of a spring and are guided to the engagement holes in a sliding contact state.

15. The wrist device according to claim 14, wherein
the case attachment includes a pair of legs arranged on one side and the other side of the first through hole and the second through hole in a communicating state.

16. The wrist device according to claim 15, wherein
the guide grooves are provided on respective inner sides of the pair of legs so as to face each other, and a distance between the facing guide grooves narrows from the end on the connecting side to the case toward the engagement holes.

17. The wrist device according to claim 1, wherein
the case attachment includes a pair of legs arranged on one side and the other side of the first through hole and the second through hole in a communicating state.

18. The wrist device according to claim 17, wherein
the case attachment has guide grooves formed from an end on a connecting side to the case toward the engagement holes, and
the guide grooves are provided on respective inner sides of the pair of legs so as to face each other, and a distance between the facing guide grooves narrows from the end on the connecting side to the case toward the engagement holes.
